(19) United States
(12) Patent Application Publication
(10) Pub. No.: US 2014/0122522 A1
(43) Pub. Date: May 1, 2014

(54) METHOD FOR PROVIDING USERS WITH HELP FROM THEIR CONTACTS WHILE SEARCHING THE WEB

(71) Applicant: Google Inc., Mountain View, CA (US)

(72) Inventors: Subramaniam GANAPATHY, Mountain View, CA (US); Sagar KAMDAR, Redwood City, CA (US); Wanda HUNG, Los Gatos, CA (US); Aron GILES, San Francisco, CA (US); Rishi KHAITAN, San Francisco, CA (US); Kumar Mayur THAKUR, West Orange, NJ (US)

(73) Assignee: Google Inc., Mountain View, CA (US)

(21) Appl. No.: 13/842,656

(22) Filed: Mar. 15, 2013

Related U.S. Application Data
(60) Provisional application No. 61/719,296, filed on Oct. 26, 2012.

(51) Int. Cl. G06F 17/30

(52) U.S. Cl. CPC G06F 17/30864
USPC 707/769

(57) ABSTRACT

The subject disclosure relates to a machine-implemented method for routing queries. The method includes receiving a query, identifying contacts associated with the user for responding to the received query, wherein the contacts are identified based on public online activity or private online activity, providing, for selection by the user, a list of recommended contacts, wherein each recommended contact is identified for responding to the received query based on the public online activity of the recommended contact, and transmitting a public notification including the received query to each of the recommended contacts selected by the user from the list of recommended contacts. The method also includes automatically transmitting a private notification including the received query to each of the contacts identified based on private online activity.

### CROSS-REFERENCE TO RELATED APPLICATIONS

The present application claims the benefit of priority under 35 U.S.C. §119 from U.S. Provisional Patent Application Ser. No. 61/719,296 entitled “A METHOD FOR PROVIDING USERS WITH HELP FROM THEIR CONTACTS WHILE SEARCHING THE WEB,” filed on Oct. 26, 2012, the disclosure of which is hereby incorporated by reference in its entirety for all purposes.

### BACKGROUND

People search the web for various kinds of information, including news, entertainment or other, harder to find information, such as other people's opinions about various topics, personal stories, factual information, accounts of other people's experiences, or collective opinions. For a user searching the web for opinions or personal stories, the information readily available on the web may be insufficient.

### SUMMARY

The subject disclosure relates generally to processing queries, and, in particular, to a computer-implemented method for routing queries. The method includes receiving a query, identifying, based on public online activity, a first set of recommended contacts associated with the user, for responding to the received query and identifying, based on private online activity, a second set of recommended contacts associated with the user, for responding to the received query. The method further includes providing the first set of recommended contacts to the user, for the user's selection, receiving an indication of a user' selection of one or more recommended contacts from the first set of recommended contacts, transmitting a public notification including the received query to each of the one or more recommended contacts selected by the user from the first set of recommended contacts and automatically transmitting a private notification including the received query to each of the recommended contacts identified in the second set of recommended contacts.

These and other aspects may include one or more of the following features. Transmitting the public notification including the received query to each of the one or more recommended contacts selected by the user from the first set of recommended contacts may further include generating the public notification including the received query for each of the one or more recommended contacts selected by the user from the first set of recommended contacts.

Transmitting the public notification including the received query to each of the one or more recommended contacts selected by the user from the first set of recommended contacts may also include providing the transmitted public notification including the received query for display in a social network stream of each of the one or more recommended contacts selected by the user from the first set of recommended contacts.

Transmitting the public notification including the received query to each of the one or more recommended contacts selected by the user from the first set of recommended contacts may likewise include providing the transmitted public notification including the received query for display in an online account associated with each of the one or more recommended contacts selected by the user from the first set of recommended contacts.

Automatically transmitting the private notification including the received query to each of the recommended contacts identified in the second set of recommended contacts may include providing the transmitted private notification including the received query for display in an online account associated with each of the recommended contacts identified in the second set of recommended contacts.

Automatically transmitting the private notification including the received query to each of the recommended contacts identified in the second set of recommended contacts may also include receiving a response to the query from the recommended contacts identified for responding to the query in the first set of recommended contacts or the second set of recommended contacts.

Automatically transmitting the private notification including the received query to each of the recommended contacts identified in the second set of recommended contacts may additionally include providing the received response for display in an online account associated with the user, wherein providing the received response for display in the online account associated with the user includes providing the received response for display in a social network stream of the user.

Automatically transmitting the private notification including the received query to each of the recommended contacts identified in the second set of recommended contacts may still further include providing the received response for display in a social network stream of the recommended contacts identified for responding to the query in the first set of recommended contacts or the second set of recommended contacts.

Automatically transmitting the private notification including the received query to each of the recommended contacts identified in the second set of recommended contacts may furthermore include receiving authorization from each of the recommended contacts from the second set of recommended contacts identified based on private online activity prior to providing the received response for display in the social network stream of the recommended contacts from the second set of recommended contacts identified based on private online activity.

According to one aspect, the method may further include categorizing the received query into one or more query topics and identifying potential recommended contacts associated with the user for responding to the received query according to the one or more categorized query topics.

According to another aspect, the method may also include determining a geographic location from which the query is received and identifying potential recommended contacts associated with the user for responding to the received query according to determined geographic location. The query may be received at a web browser.

Automatically transmitting the private notification including the received query to each of the recommended contacts identified in the second set of recommended contacts may include transmitting a private message to each of the recommended contacts.

The subject disclosure also relates to a machine-readable medium with instructions stored therein, which when executed by the processors, cause the processors to perform operations that include receiving a web browser query, categorizing the received web browser query into one or more query topics, identifying contacts associated with the user for responding to the received web browser query according to the one or more categorized query topics, wherein the contacts are identified based on public online activity of the contacts or private online activity of the contacts and providing, for selection by the user, a list of recommended contacts, wherein each recommended contact is identified for responding to the received web browser query based on the public online activity of the recommended contact. The operations also include receiving an indication of a user selection of the contacts identified based on public online activity, from the list of recommended contacts, transmitting a public notification including the received web browser query to each the contacts selected by the user and automatically transmitting a private notification including the received web browser query to each of the contacts identified based on private online activity.

These and other aspects may include one or more of the following features. Transmitting the public notification including the received web browser query to each of the contacts selected by the user from the list of recommended contacts may include one or more of providing the transmitted public notification including the received web browser query for display in a social network stream of each the contacts selected by the user from the list of recommended contacts, providing the transmitted public notification including the received web browser query for display in an online account associated with each of the recommended contacts selected by the user from the list of recommended contacts or providing the transmitted private notification including the received web browser query for display in an online account associated with each of the contacts identified based on private online activity.

According to one aspect, the operations may further include receiving a response to the query from the contacts identified for responding to the query or providing the received response for display in an online account associated with the user. Providing the received response for display in the online account associated with the user may include providing the received response for display in a social network stream of the user. The operations may also include providing the received response for display in a social network stream of the contacts identified for responding to the received query.

According to one aspect, the operations may also include receiving authorization from each of the contacts identified based on private online activity prior to providing the received response for display in the social network stream of the contacts identified based on private online activity. Automatically transmitting the private notification including the received web browser query to the contacts identified based on private online activity may include transmitting a private message to the contacts identified based on private online activity.

Still further, the operations may include determining a geographic location from which the web browser query is received and identifying contacts associated with the user for responding to the received query according to determined geographic location.

The disclosure also provides a system for routing queries and includes a query module, configured to receive a query, a contacts module configured to identifying contacts associated with a user for responding to the received query, wherein the contacts are identified based on public online activity or private online activity and to provide, for selection by the user, a list of recommended contacts, wherein each recommended contact is identified for responding to the received query based on the public online activity of the recommended contact, and a routing module configured to transmit a public notification including the received query to each recommended contacts selected by the user and to automatically transmit a private notification including the received query to each contact identified based on private online activity.

The system may also include a publishing module configured to provide the transmitted public notification including the received query for display to each of the recommended contacts selected by the user from the list of recommended contacts. The publishing module may be further configured to receive a response to the query from the contacts identified for responding to the query and provide the received response for display.

These and other aspects may provide one or more of the following advantages. Users may be able to receive help on certain topics from their most qualified friends, while searching the web. Users are reminded that they can ask questions of their friends, not just the web. This may be particularly useful when a user is looking for information that is hard to obtain through web searches, such as opinions, personal stores, collective opinions or personal accounts. The advantages may also include enabling users to get answers to difficult questions more easily and quickly by routing the users' questions to their friends.

User's queries regarding certain topics are thus routed to user's friends who, according to various processes disclosed herein, are identified by the system as having knowledge that is pertinent to the queried topic. An additional advantage of an aspect of the disclosed technology is that a user's friends who are identified based on their personal online activity are not disclosed to the user as an expert on the queried topic until the user's friend decides that he or she wishes to be disclosed and chooses to respond to the user's query. The friend's identity and personal online activity are therefore kept private, until the user's friend wishes to share his or her identity and expertise.

It is understood that other configurations of the subject technology will become readily apparent from the following detailed description, where various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several implementations of the subject technology are set forth in the following figures.

FIG. 1 is a diagram of an exemplary system for routing queries.

FIG. 2 illustrates a flow diagram of an example process for routing queries.

FIG. 3 conceptually illustrates a diagram of an example graphic user interfaces from which a query may be routed to a contact associated with the user.

FIG. 4 conceptually illustrates an example of system 400 for routing queries.

FIG. 5 conceptually illustrates an electronic system with which some aspects of the subject technology are implemented.

### DETAILED DESCRIPTION

In the following detailed description, numerous specific details are set forth to provide a full understanding of the present disclosure. It will be apparent, however, to one ordinarily skilled in the art that the embodiments of the present disclosure may be practiced without some of these specific details. In other instances, well-known structures and techniques have not been shown in detail so as not to obscure the disclosure.

Information such as people's opinions about various topics, personal stories, factual information, accounts of other people's experiences, or collective opinions is often hard to find on the web because it tends to exist in blogs or other semi-private forums. For a user searching the web for opinions or personal stories, the information available on the web may be insufficient. Quality information, such as the most relevant or interesting opinions about a particular topic may, in fact, be that, from people with whom the user is associated or affiliated in some way. For example, opinions of people associated with the user at a social networking site may be useful and interesting to a user because of the pre-existing relationship and, perhaps, common values.

According to various aspects of the subject technology, systems and methods are provided for routing queries. The disclosure of the present technology provides a process by which a user searching the web may contemporaneously ask his personal contacts for help on a topic the user is researching. According to an aspect of the disclosed technology, as the user searches the web and reviews search results returned by a browser, the user is provided with a user interface element such as a text box into which the user may type a question directed to one or more contacts associated with the user. Such user questions are hereinafter referred to as queries. Thus, without limitation, a query may be received at a system by user entry at a graphic user interface for routing queries to contacts. Alternatively, a query may be received from the web browser search box when the user enters the search query at the time the user searches the web. The query may automatically be populated by the system in a graphic user interface for routing queries to contacts. A query may also be received from a user at a web browser or other online account's search box and processed according to the methods disclosed herein. Contacts associated with the user may include the user's contacts at a social networking site, contacts from the user's email list, a user's followers at an online blogging service, or other contacts associated with the user.

When the query is received at the system, one or more contacts who are able to help the user on the topic of the query are identified. Contacts may be identified based on their public or personal online activity. Contacts are identified when it is determined that the contact's online activity data contains information that is relevant to the user's query and that the contact may be able to help the user or respond to the user's query. For example, a contact's browsing or posting history may be used for determinations regarding whether the contact may help with a query.

When a contact is identified based on his or her public online activity, the contact is presented to the user in a list of recommended contacts, from which the user may select one or more contacts for responding to the user' query. Selected contacts receive a public notification that they may be able to answer the user's question. The public notification may include, but is not limited to, posting the query to the contact's online account, such as, for example, a social networking site. The phrase “social networking site” as used herein encompasses its plain and ordinary meaning, including, but not limited to, an online service, platform or site that focuses on building and reflecting social associations and interactions among users. Users of a social networking site may create social associations with one another (e.g., identify other users as connections). Such user associations may be defined on a user-to-user basis, or as a group of users associated through membership within a group. The user associations may be symmetrical or asymmetrical.

Alternatively, the user's query may be published in a web browser or an online blogging service. The contact may then type his or her answer in the same account where the query was published. When the query is published in the social network streams of the one or more selected contacts, the query may be published as a special kind of social network post. The selected contact may answer the published query by posting a comment in the post's comment string.

The query may be sent along with the notification to the selected contacts. The notification may be displayed to the contact in a graphic user interface of an online account at which the user is logged in. The online account may include but is not limited to, a social networking site, a web browser, an online blogging service or the like. There may be a special graphic user element for notifications about queries the selected contact receives, and a notification badge may call the selected contact's attention to a new question the contact received.

The public online activity that may be relevant to identifying contacts for responding to the user's query includes the contact's public social network content, such as posts, photos, links, online activity, or public profile data. The contacts may be associated with the user through, for example, a social network, or be selected from the user's email contact list.

In parallel to identifying contacts identified based on their public online activity, as described above, another category of contacts is identified by the system, but those contacts' identity is not disclosed to the user until such contact agrees to answer the user's query. Such contacts are referred to herein as “anonymous contacts.” Anonymous contacts are not openly recommended to the user, to help safeguard the anonymous contacts' privacy. The anonymous contacts are associated with the user, but they are selected based on their personal online activity, rather than public online activity. Relevant personal online activity that is used to identify anonymous contacts may include private social network posts, web browsing history, or privately shared photos, for example.

When it is determined that the anonymous contacts' personal online activity contains information that may help answer the user's query, the contact is automatically notified of the user's query via a private notification. The notification may include the user's query. For example, the query and notification may be sent to the identified contact via a private message at a social networking site or another online account such as a web browser. The user, however, is not aware of the private notifications to the anonymous contacts. Anonymous contacts are not known by the user until the anonymous contact answers the user's query and agrees to have his identity disclosed. According to an aspect of the disclosed subject matter, private notifications to anonymous contacts may include a request for authorization to provide the contact's answer to the user. Once the authorization is received, the answer may be published in the contact's social network stream, the user's social network stream or another online account of the user.

The user may also independently select and add contacts whose help is desired. The user's question is then published in the one or more independently selected contacts' social network streams or another online account such as a web browser, and the independently selected contacts receive a notification that the user has asked them a question. Any contact may opt out of receiving questions from other users. There may also be global experts who are not directly associated with the user, but who are flagged in the system as experts on the topic of the user's query, and such global experts may receive notifications according to the methods described herein. The answers may then be rated by the user and others. When a contact's answer receives a high rank from the user or others, the contact's rating as an answeror may be increased, and that contact may receive precedence over other, lower rated contacts, on similar queries in the future.

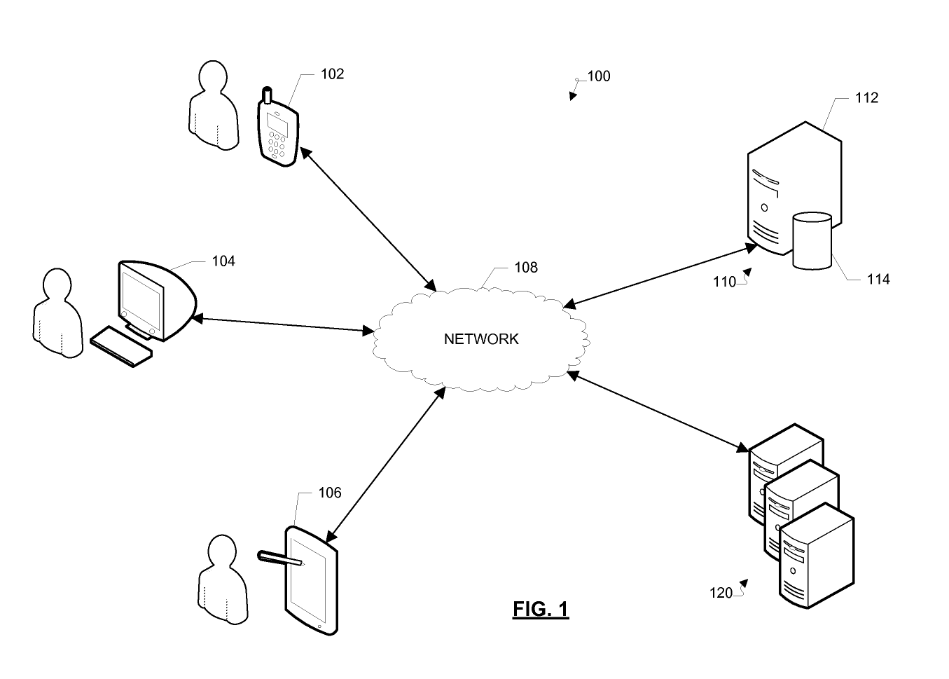

FIG. 1 illustrates an example client-server network environment which provides for routing queries. A network environment 100 includes a number of electronic devices 102, 104 and 106 communicably connected to a server 110 by a network 108. Server 110 includes a processing device 112 and a data store 114. Processing device 112 executes computer instructions stored in data store 114, for example, to receive queries, identify contacts and transmit private and public notifications. Data store 114 may store information pertaining to associations between users and contacts, for example.

Processing device 112 may identify contacts based on private and public online activity, generate a list of recommended contacts identified based on public online activity and transmit notifications. Processing device 112 may also determine how a query may be published.

Servers 110 or application servers 120 may host online accounts such as a web browser and a social networking site within which some of the processes discussed herein are implemented. In some example aspects, electronic devices or client devices, as used interchangeably herein, 102, 104 and 106 can be computing devices such as laptop or desktop computers, smartphones, PDAs, portable media players, tablet computers, televisions or other displays with one or more processors coupled thereto or embedded therein, or other appropriate computing devices that can be used to for displaying a web page or web application.

In the example of FIG. 1, electronic device 102 is depicted as a smartphone, electronic device 104 is depicted as a desktop computer, and electronic device 106 is depicted as a PDA. A client in an application or a system that accesses a service made available by a server which is often (but not always) located on another computer system accessible by a network. Some client applications may be hosted on a website, whereby a browser is a client. Such implementations are within the scope of the subject disclosure, and any reference to client may incorporate a browser and reference to server may incorporate a website.

The system (e.g., hosted at server 110), receives a query from a client device (e.g., electronic devices 102, 104 or 106). Upon receiving the query, contacts associated with the user who sent the query are identified. A list of contacts recommended based on their public online activity is presented to the user for selection, and based on user selection, public notifications are sent to those selected contacts. Private notifications are automatically transmitted to contacts identified based on private online activity.

Application servers 120 may host various applications responsible routing queries. In some example aspects, server 110 can be a single computing device such as a computer server. In other embodiments, server 110 can represent more than one computing device working together to perform the actions of a server computer (e.g., cloud computing). The server 110 may host the web server communicationally coupled to the browser at the client device (e.g., electronic devices 102, 104 or 106) via network 108.

The network 108 can include, for example, any one or more of a personal area network (PAN), a local area network (LAN), a campus area network (CAN), a metropolitan area network (MAN), a wide area network (WAN), a broadband network (BBN), the Internet, and the like. Further, the network 108 can include, but is not limited to, any one or more of the following network topologies, including a bus network, a star network, a ring network, a mesh network, a star-bus network, tree or hierarchical network, and the like.

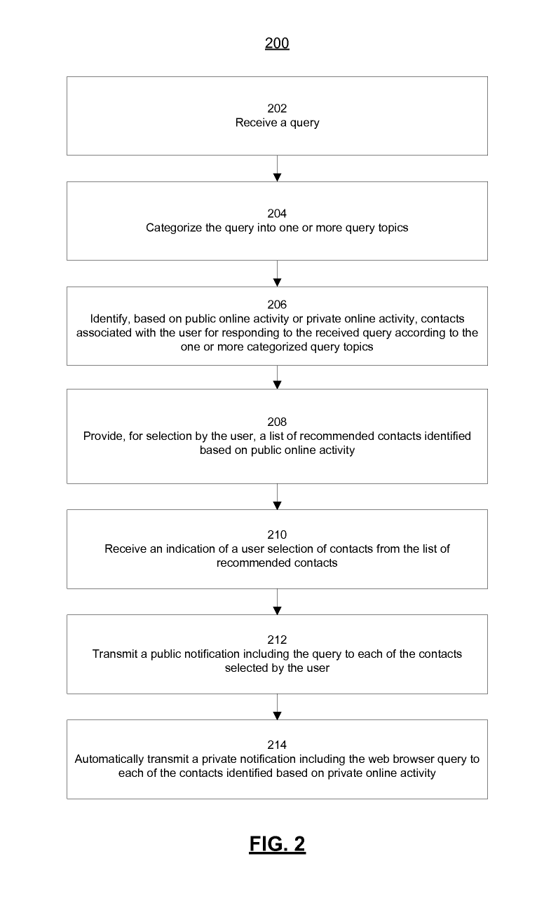

FIG. 2 illustrates a flow diagram of an example process 200 for routing a query. At block 202, a query is received at the system. The query may be entered by a user at a client device, during, for example, a web browsing session or in another online environment. The query may be entered at a graphic user element such as search box and may consist of free-form text, images, links, photographs or other electronic content.

The received query may be the same query that was entered by the user for the web browsing session. The received query may also be a new query that was entered at a graphic user interface for routing queries to contacts. The query may be entered after the search results for the web browsing session have been returned by the web browser. Or, the query may automatically be generated by the system based on the user's last search in the web browsing history.

At block 202, the received query is categorized into one or more query topics. Various known language and image processing techniques may be employed to categorize the received query into one or more query topics. Query topics may also be generated by the system in response to a received query and presented for selection to the user. The user may be provided with an option to approve a system-generated query topics.

Upon categorizing the received query into one or more query topics, contacts associated with the user are identified for responding to the received query at block 204. The contacts are identified based on the contacts' public online activity or private online activity. The contacts may be separated into a first set of contacts and a second set of contacts, based on the kind of online activity that is used. A first set of contacts for responding to the received query may be identified based on public online activity. A second set of recommended contacts may be identified for responding to the received query based on private online activity.

The public online activity that may be relevant to identifying contacts for responding to the user's query includes, but is not limited to, a contact's public social network content, such as posts, photos, links, online activity, or public profile data. Private online activity may include, but is not limited to, private social network posts, web browsing history, or privately shared photos, for example. The various types of online activity are analyzed with respect to the received query and the query topics. For example, text processing techniques may be implemented to analyze a particular online activity of a contact to determine whether the activity relates to the query and the query topics. Image processing may also be done to determine whether a particular online activity of a contact relates to a query and the query topics. Sentiment analysis may also be performed to better identify an online activity that relates to the query. Contacts whose online activity relates to the query and the query topics are thus identified.

According to an aspect of the disclosed technology, identified contacts may be filtered based on additional parameters such as geography, affinity scores, frequency of communication, or other factors. That is, contacts who are geographically closer to a user may be preferable when the user is searching for local information. Also, contacts with whom the user interacts frequently may be deemed preferable to contacts who rarely interact with the user. Contacts who appear to be closer connected to the user and have a higher affinity score may be rated higher than other contacts. There may also be a category of contacts who are deemed “global experts” who may be suggested to the user even when they are not associated with the user at a social networking site. A global expert may be suggested to the user when the global expert is knowledgeable in the query topic, as indicated by the global expert's history of responding to other users on the query topic or similar topics. Global experts may be suggested whether the expert is known or unknown to the user, when the level of expertise on a given query topic high and such suggestion may be beneficial to the user. Global experts may also be suggested when not enough contacts who are associated with the user are identified or when the level of expertise among the contacts associated with the user appears low.

At block 208, a list of recommended contacts identified based on their public online activity is provided to the user. The user may select from the list of recommended contacts one or more contacts to whom the user wishes to send the query. At block 210, the user's selection of contacts from the list of recommended contacts is received. At block 212, a public notification is transmitted to each of the contacts selected by the user. The notification may include the received query. Notifying a contact may include, but is not limited to, providing the transmitted public notification for display in a social network stream of each of the recommended contacts selected by the user from the list of recommended contacts. The notification may also be provided in another online account at which the contact is logged in. For example, a notification may appear on a web browser screen when the contact is logged in at a web browser that is associated with the same ID as the social networking site at which the user and contact are connected. Any online account that is associated with a selected contact and shares the same ID with a social networking site at which the user and the contact are connected, may receive the notification.

At block 214, a private notification is automatically transmitted to each of the contacts identified based on private online activity. Such contacts are referred to herein as anonymous contacts. The notification to the anonymous contacts may include the received query. The user, however, is not aware of the anonymous contacts receiving such private notifications. Only when an anonymous contact has indicated that he or she wishes to answer the user's query and to have his or her identity disclosed to the user, does the user learn about the anonymous contact having received the user's query. According to an aspect of the disclosed subject matter, private notifications to anonymous contacts may include a request for authorization to provide the contact's answer to the user. Once the authorization is received, the answer may be published in the contact's social network stream, the user's social network stream or another online account of the user.

One or more contacts identified based on private or public online activity may respond the user's query, and the response may be provided for display in, for example, a social network stream of the user, an online account associated with the user or the social network stream of the identified contact

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

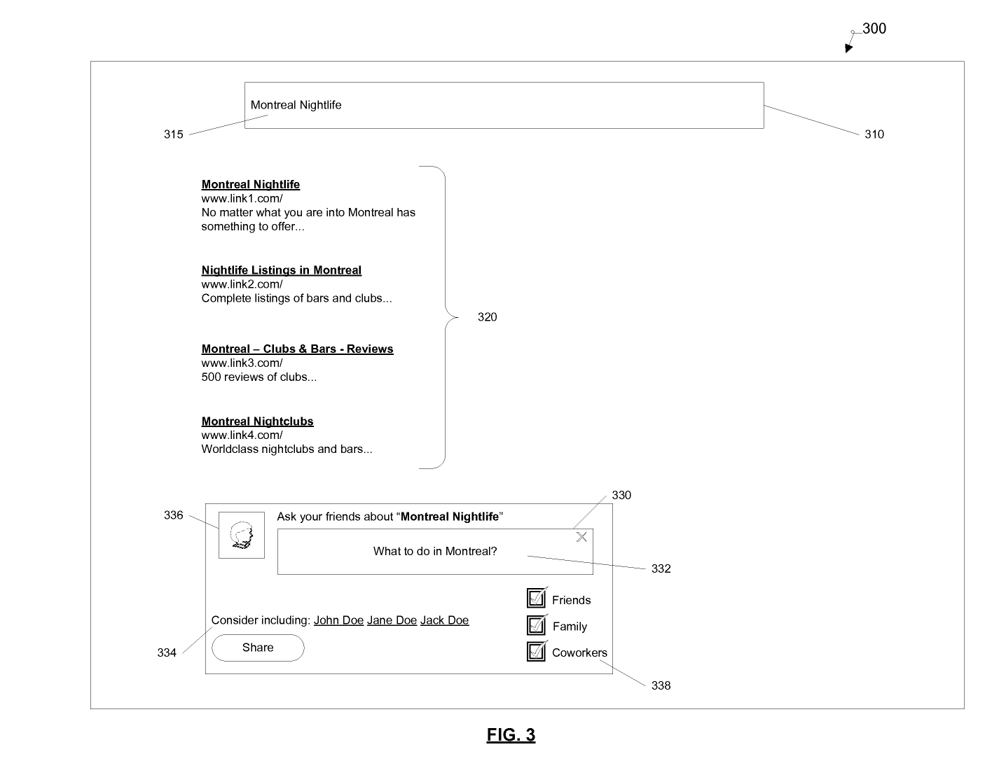

FIG. 3 conceptually illustrates a diagram of an example graphic user interfaces from which a query may be routed to one or more contacts associated with the user. FIG. 3A shows a search box 310 in which a user may enter search query 315 for “Montreal Nightlife.” The search query 315 may be a web browser query or another type of online search. Search results 320 are provided by the search engine in response to the search query 315. Graphic user interface 330 illustrates a graphic user interface for routing queries to contacts. The graphic user interface 330 may be a text box, for example. User 336 may enter a new query 332 at graphic user interface 330. The query that is routed to contacts and used to generate the list of recommended contacts 334 may be search query 315, or the new query 332. Based on the search query 315 or on the new query 332, recommended contacts 334 are provided to User 336. Additional categories of contacts 338, such as the user's friends, family or co-workers, may also be selected by User 336 for help with responding to a query.

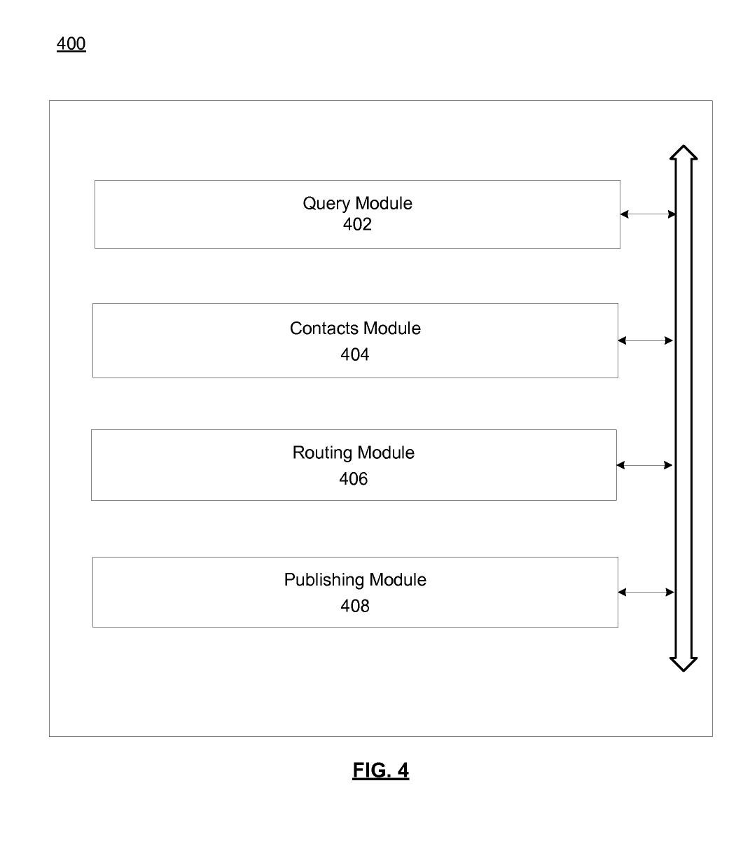

FIG. 4 illustrates an example of system 400 for routing queries in accordance with various aspects of the subject technology. System 400 comprises a Query module 402, a Contacts module 404, a Routing module 406 and a Publishing module 408. The Query module 402 is configured to receive queries entered by a user. A query may be received at a web browser, for example. The Contact module 404 is configured to identify contacts associated with a user for responding to the received query, wherein the contacts are identified based on public online activity or private online activity and to provide, for selection by the user, a list of recommended contacts, wherein each recommended contact is identified for responding to the received query based on the public online activity of the recommended contact. The Routing module 406 is configured to transmit a public notification including the received query to each recommended contact selected by the user and to automatically transmit a private notification including the received query to each contact identified based on private online activity. The Publishing module 408 is configured to provide the transmitted public notification including the received query for display to each of the recommended contacts selected by the user from the list of recommended contacts, to receive a response to the query from the contacts identified for responding to the query and to provide the received response for display.

These modules may be in communication with one another. In some aspects, the modules may be implemented in software (e.g., subroutines and code). In some aspects, some or all of the modules may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both. Additional features and functions of these modules according to various aspects of the subject technology are further described in the present disclosure.

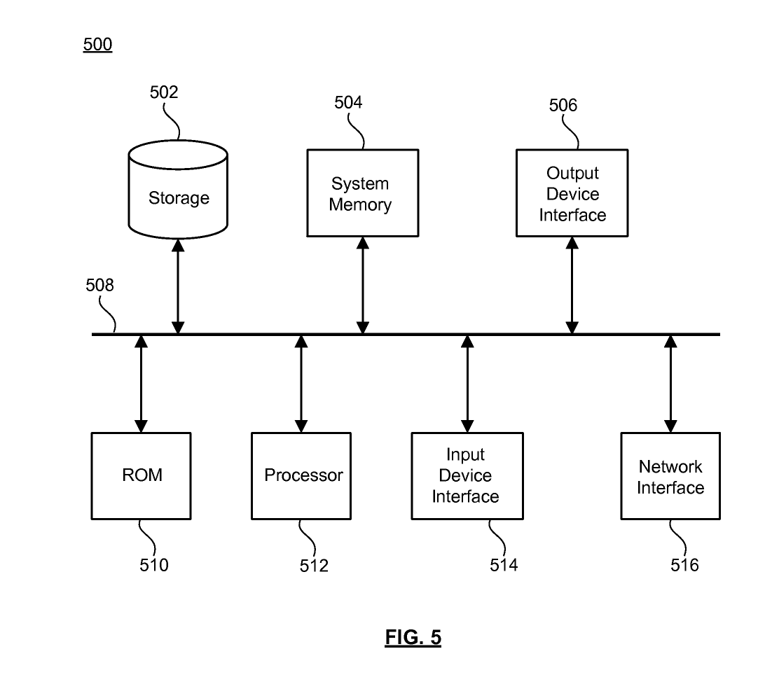

FIG. 5 conceptually illustrates an electronic system with which some aspects of the subject technology are implemented. Electronic system 500 can be a server, computer, phone, PDA, laptop, tablet computer, television with one or more processors embedded therein or coupled thereto, or any other sort of electronic device. Such an electronic system includes various types of computer readable media and interfaces for various other types of computer readable media. Electronic system 500 includes a bus 508, processing unit(s) 512, a system memory 504, a read-only memory (ROM) 510, a permanent storage device 502, an input device interface 514, an output device interface 506, and a network interface 516.

Bus 508 collectively represents all system, peripheral, and chipset buses that communicatively connect the numerous internal devices of electronic system 500. For instance, bus 508 communicatively connects processing unit(s) 512 with ROM 510, system memory 504, and permanent storage device 502.

From these various memory units, processing unit(s) 512 retrieves instructions to execute and data to process in order to execute the processes of the subject disclosure. The processing unit(s) can be a single processor or a multi-core processor in different implementations.

ROM 510 stores static data and instructions that are needed by processing unit(s) 512 and other modules of the electronic system. Permanent storage device 502, on the other hand, is a read-and-write memory device. This device is a non-volatile memory unit that stores instructions and data even when electronic system 500 is off. Some implementations of the subject disclosure use a mass-storage device (such as a magnetic or optical disk and its corresponding disk drive) as permanent storage device 502.

Other implementations use a removable storage device (such as a floppy disk, flash drive, and its corresponding disk drive) as permanent storage device 502. Like permanent storage device 502, system memory 504 is a read-and-write memory device. However, unlike storage device 502, system memory 504 is a volatile read-and-write memory, such a random access memory. System memory 504 stores some of the instructions and data that the processor needs at runtime. In some implementations, the processes of the subject disclosure are stored in system memory 504, permanent storage device 502, and/or ROM 510. From these various memory units, processing unit(s) 512 retrieves instructions to execute and data to process in order to execute the processes of some implementations.

Bus 508 also connects to input and output device interfaces 514 and 506. Input device interface 514 enables the user to communicate information and select commands to the electronic system. Input devices used with input device interface 514 include, for example, alphanumeric keyboards and pointing devices (also called “cursor control devices”). Output device interfaces 506 enables, for example, the display of images generated by the electronic system 500. Output devices used with output device interface 506 include, for example, printers and display devices, such as cathode ray tubes (CRT) or liquid crystal displays (LCD). Some implementations include devices such as a touchscreen that functions as both input and output devices.

Finally, as shown in FIG. 5, bus 508 also couples electronic system 500 to a network (not shown) through a network interface 516. In this manner, the computer can be a part of a network of computers (such as a local area network (“LAN”), a wide area network (“WAN”), or an Intranet, or a network of networks, such as the Internet. Any or all components of electronic system 500 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD−RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of exemplary approaches. Based upon design preferences, it is understood that the specific order or hierarchy of steps in the processes may be rearranged, or that some illustrated steps may not be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims.

What is claimed is:

1. A computer-implemented method for routing a query received from a user, the method comprising:
receiving a query;
identifying, based on public online activity, a first set of recommended contacts associated with the user, for responding to the received query;
identifying, based on private online activity, a second set of recommended contacts associated with the user, for responding to the received query;
providing the first set of recommended contacts to the user, for the user's selection;
receiving an indication of a user' selection of one or more recommended contacts from the first set of recommended contacts;
transmitting a public notification including the received query to each of the one or more recommended contacts selected by the user from the first set of recommended contacts; and
automatically transmitting a private notification including the received query to each of the recommended contacts identified in the second set of recommended contacts.

2. The computer-implemented method of claim 1, wherein transmitting the public notification including the received query to each of the one or more recommended contacts selected by the user from the first set of recommended contacts further comprises:
generating the public notification including the received query for each of the one or more recommended contacts selected by the user from the first set of recommended contacts.

3. The computer-implemented method of claim 1, wherein transmitting the public notification including the received query to each of the one or more recommended contacts selected by the user from the first set of recommended contacts further comprises:
providing the transmitted public notification including the received query for display in a social network stream of each of the one or more recommended contacts selected by the user from the first set of recommended contacts.

4. The computer-implemented method of claim 1, transmitting the public notification including the received query to each of the one or more recommended contacts selected by the user from the first set of recommended contacts further comprises:
providing the transmitted public notification including the received query for display in an online account associated with each of the one or more recommended contacts selected by the user from the first set of recommended contacts.

5. The computer-implemented method of claim 1, wherein automatically transmitting the private notification including the received query to each of the recommended contacts identified in the second set of recommended contacts further comprises:
providing the transmitted private notification including the received query for display in an online account associated with each of the recommended contacts identified in the second set of recommended contacts.

6. The computer-implemented method of claim 1, further comprising:
receiving a response to the query from the recommended contacts identified for responding to the query in the first set of recommended contacts or the second set of recommended contacts.

7. The computer-implemented method of claim 6, further comprising:
providing the received response for display in an online account associated with the user.

8. The computer-implemented method of claim 7, wherein providing the received response for display in the online account associated with the user includes providing the received response for display in a social network stream of the user.

9. The computer-implemented method of claim 6, further comprising:
providing the received response for display in a social network stream of the recommended contacts identified for responding to the query in the first set of recommended contacts or the second set of recommended contacts.

10. The computer-implemented method of claim 9, further comprising:
receiving authorization from each of the recommended contacts from the second set of recommended contacts identified based on private online activity prior to providing the received response for display in the social network stream of the recommended contacts from the second set of recommended contacts identified based on private online activity.

11. The computer-implemented method of claim 1, further comprising:
categorizing the received query into one or more query topics; and
identifying potential recommended contacts associated with the user for responding to the received query according to the one or more categorized query topics.

12. The computer-implemented method of claim 1, further comprising:
determining a geographic location from which the query is received; and
identifying potential recommended contacts associated with the user for responding to the received query according to determined geographic location.

13. The computer-implemented method of claim 1, wherein the query is received at a web browser.

14. The computer-implemented method of claim 1, wherein automatically transmitting the private notification including the received query to each of the recommended contacts identified in the second set of recommended contacts, comprises transmitting a private message to each of the recommended contacts.

15. A machine-readable medium comprising instructions stored therein, which when executed by the processors, cause the processors to perform operations comprising:
receiving a web browser query;
categorizing the received web browser query into one or more query topics;
identifying contacts associated with the user for responding to the received web browser query according to the one or more categorized query topics, wherein the contacts are identified based on public online activity of the contacts or private online activity of the contacts;
providing, for selection by the user, a list of recommended contacts, wherein each recommended contact is identified for responding to the received web browser query based on the public online activity of the recommended contact;
receiving an indication of a user selection of the contacts identified based on public online activity, from the list of recommended contacts;
transmitting a public notification including the received web browser query to each the contacts selected by the user; and
automatically transmitting a private notification including the received web browser query to each of the contacts identified based on private online activity.

16. The machine-readable medium of claim 15, wherein transmitting the public notification including the received web browser query to each of the contacts selected by the user from the list of recommended contacts further comprises:
providing the transmitted public notification including the received web browser query for display in a social network stream of each the contacts selected by the user from the list of recommended contacts.

17. The machine-readable medium of claim 15, wherein transmitting the public notification including the received web browser query to each of the contacts selected by the user from the list of recommended contacts further comprises:
providing the transmitted public notification including the received web browser query for display in an online account associated with each of the recommended contacts selected by the user from the list of recommended contacts.

18. The machine-readable medium of claim 15, wherein automatically transmitting the private notification including the received query to each of the contacts identified based on private online activity further comprises:
providing the transmitted private notification including the received web browser query for display in an online account associated with each of the contacts identified based on private online activity.

19. The machine-readable medium of claim 15, the operations further comprising:
receiving a response to the query from the contacts identified for responding to the query.

20. The machine-readable medium of claim 19, further comprising:
providing the received response for display in an online account associated with the user.

21. The machine-readable medium of claim 20, wherein providing the received response for display in the online account associated with the includes providing the received response for display in a social network stream of the user.

22. The machine-readable medium of claim 19, further comprising:
providing the received response for display in a social network stream of the contacts identified for responding to the received query.

23. The machine-readable medium of claim 22, further comprising:
receiving authorization from each of the contacts identified based on private online activity prior to providing the received response for display in the social network stream of the contacts identified based on private online activity.

24. The machine-readable medium of claim 15, wherein automatically transmitting the private notification including the received web browser query to the contacts identified based on private online activity comprises transmitting a private message to the contacts identified based on private online activity.

25. The machine-readable medium of claim 15, further comprising:
determining a geographic location from which the web browser query is received; and
identifying contacts associated with the user for responding to the received query according to determined geographic location.

26. A system for routing queries, the system comprising:
a query module, configured to receive a query;
a contacts module configured to identifying contacts associated with a user for responding to the received query, wherein the contacts are identified based on public online activity or private online activity and to provide, for selection by the user, a list of recommended contacts, wherein each recommended contact is identified for responding to the received query based on the public online activity of the recommended contact; and
a routing module configured to transmit a public notification including the received query to each recommended contacts selected by the user and to automatically transmit a private notification including the received query to each contact identified based on private online activity.

27. The system of claim 26, further comprising:
a publishing module configured to provide the transmitted public notification including the received query for display to each of the recommended contacts selected by the user from the list of recommended contacts.

28. The system of claim 26, wherein the publishing module is further configured to:
receive a response to the query from the contacts identified for responding to the query; and
provide the received response for display.
